(19) United States
(12) Patent Application Publication
(10) Pub. No.: US 2026/0203133 A1
(43) Pub. Date: Jul. 16, 2026

(54) ALLOCATING RESOURCES TO APPLICATIONS IN A COMPUTING ENVIRONMENT

(71) Applicant: INTERNATIONAL BUSINESS MACHINES CORPORATION, ARMONK, NY (US)

(72) Inventors: HUI WANG, BEIJING (CN); Yu Mei Dai, Changping District (CN); Xiang Yu Xue, Rizhao City (CN); Mai Zeng, Shi Jing Shan (CN); Wei Li, BEIJING (CN); Peng Hui Jiang, Beijing (CN); Xiao Chen Huang, Beijing (CN)

(21) Appl. No.: 19/026,032

(22) Filed: Jan. 16, 2025

(51) Int. Cl. G06F 9/50; G06N 20/00

(52) U.S. Cl. CPC G06F 9/5055; G06F 9/5038; G06N 20/00

(57) ABSTRACT

Provided are a computer implemented method, system, and computer program product for allocating resources to applications in a computing environment. Performance metrics and resource usage information are collected for applications. The collected performance and resource usage information for the applications are inputted to application models for the applications to generate first allocations of resources for the applications, wherein there is one application model for each application. The first allocations of the resources and current allocations of resources to the applications are inputted to an overall model to generate second allocations of the resources for the applications to optimize allocations of resources across the applications. The resources to the applications are allocated according to the second allocations of the resources.

### BACKGROUND OF THE INVENTION

### 1. Field of the Invention

The present invention relates to a computer implemented method, system, and computer program product for allocating resources to applications in a computing environment.

### 2. Description of the Related Art

Computer applications executing in a shared computing environment may start to experience errors and decreased performance when resources allocated to the applications become low, such as when available storage, memory, and processing resources are substantially low. System administrators or users will then have to reconfigure the computing environment to release and reallocate resources, such as delete files from storage, add more virtual or physical memory and processing power, or reallocate resources among applications.

### SUMMARY

Provided are a computer implemented method, system, and computer program product for allocating resources to applications in a computing environment. Performance metrics and resource usage information are collected for applications. The collected performance and resource usage information for the applications are inputted to application models for the applications to generate first allocations of resources for the applications, wherein there is one application model for each application. The first allocations of the resources and current allocations of resources to the applications are inputted to an overall model to generate second allocations of the resources for the applications to optimize allocations of resources across the applications. The resources to the applications are allocated according to the second allocations of the resources.

### BRIEF DESCRIPTION OF THE DRAWINGS

FIG. 1 illustrates an embodiment of a resource allocation system to allocate resources to applications in a computing environment.

FIG. 2 illustrates an embodiment of an application resource allocation of resources allocated to an application.

FIG. 3 illustrates an embodiment of an application training set to train an application model to output application resource allocations.

FIG. 4 illustrates an embodiment of an overall model training set to train an overall model to adjust the resource allocations from the application models to optimize allocations across applications.

FIG. 5 illustrates an embodiment of operations to allocate resources to applications in a computing environment.

FIG. 6 illustrates an embodiment of operations to train application models and the overall model to optimize output of allocation of resources to the applications.

FIG. 7 illustrates a Lagrangian relaxation technique to train the application and overall models to optimize resource allocations to applications.

FIG. 8 illustrates a computing environment in which the components of FIG. 1 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer implemented method for allocating resources to applications in a computing environment. The method comprises collecting performance metrics and resource usage information for applications. The method further comprises inputting the collected performance and resource usage information for the applications to application models for the applications to generate first allocations of resources for the applications, wherein there is one application model for each application. The method further comprises inputting the first allocations of the resources and current allocations of resources to the applications to an overall model to generate second allocations of the resources for the applications to optimize allocations of resources across the applications. The method further comprises allocating the resources to the applications according to the second allocations of the resources. Thus, embodiments advantageously twice optimize resource allocations. First within applications and, second, the application specific optimal resource allocations are adjusted to optimize across all applications and the computing environment as a whole.

Example 2: The limitations of any of Examples 1 and 3-11 may optionally include that the application models and the overall model comprise machine learning models. Thus, embodiments advantageously allow the use of machine learning models to perform the optimizations to allow for dynamic adjustment based on dynamically changing performance metrics and resource usage information for the applications in the computing environment.

Example 3: The limitations of any of Examples 1, 2 and 4-11 may optionally include that the collecting the performance and resource usage information for the applications comprises determining whether a metric based on the collected performance and resource usage information for an application satisfies a threshold requirement for the metric. The inputting the collected performance and resource usage information to the application models, the inputting the first allocations and the current allocations of resources, and the allocating the resources according to the second allocations are performed in response to determining that the metric satisfies the threshold requirement. Thus, embodiments advantageously require that a change in performance and resource usage in the computing environment satisfy a threshold change before adjusting the allocation of resources to the application to avoid frequently changing resource allocations for minimal changes to resource usage and performance.

Example 4: The limitations of any of Examples 1-3 and 5-11 may optionally include that the inputs to the overall model to generate the second allocations include categories and priorities of the applications. Thus, embodiments advantageously allow for consideration of application categories and priorities to determine the allocation of resources to favor application categories and priorities indicating critical applications versus non-critical applications.

Example 5: The limitations of any of Examples 1-4 and 6-11 may optionally include that the performance metrics for the applications is selected from the group consisting of response time of requests to the applications, Input/Output throughput at the applications, read/write rate, and error rates. The resource usage information is selected from the group consisting of allocated processor resources, allocated memory resources, and allocated storage for filesystems used by the applications. Thus, embodiments advantageously consider such important metrics as response time of requests, Input/Output throughput, error rates and available resource levels to determine how to optimally allocate resources.

Example 6: The limitations of any of Examples 1-5 and 7-11 may optionally include that the first and the second allocations indicate for the applications a positive adjustment to increase a resource allocation to an application, a negative adjustment to decrease the resource allocation to an application, and indication to leave a resource allocation to an application unchanged. Thus, embodiments advantageously determine adjustments for the resource allocations to be applied to the current allocations.

Example 7: The limitations of any of Examples 1-6 and 8-11 may optionally include that the resources include filesystems and the threshold allocation limits indicate storage utilization limits for the filesystems. The overall model produces the second allocations to reassign an amount of storage resources from a filesystem such that a storage utilization of the filesystem, from which storage resources are reassigned, remains within a storage utilization limit for the filesystem. Thus, embodiments advantageously allow the overall model to produce allocations of filesystem storage resources that maintain allocations within a storage utilization limit so filesystems are not oversubscribed.

Example 8: The limitations of any of Examples 1-7 and 9-11 may optionally include that the application models comprise machine learning models. Training sets for an application model for an application of the application models include input comprising performance and resource usage information for the application, an outputted allocation of resources to the application from the application model, and a label for the outputted allocation indicating a negative result or positive result. The application model is trained with the input performance metrics and resource usage information in a first training set to output the outputted allocation of the resources indicated in the first training set with a low confidence level in response to the label indicating the negative result. The application model is trained with the input performance metrics and resource usage information in a second training set to output the outputted allocation of the resources indicated in the second training set with a high confidence level in response to the label indicating the positive result. Thus, embodiments advantageously allow for retraining of the application models based on previously processed inputs, outputs resulting from the inputs and a label indicating whether the outputs are positive or negative to reinforce the application models to produce positive outputs and not produce negative output results for the inputs.

Example 9: The limitations of any of Examples 1-8, 10, and 11 may optionally include that the application models are trained using a Lagrangian relaxation optimization technique that calculates adjustment rates of allocations of the resources optimized using a Lagrangian dual problem to perform a min-max of an application score function for a performance type. Thus, embodiments advantageously use Lagrangian relaxation optimization techniques to perform min-max optimizations of the application models.

Example 10: The limitations of any of Examples 1-9 and 11 may optionally include that the overall model comprises a machine learning model. Training sets for the overall model include input comprising first allocations of resources for the applications, the current allocations of resources to the applications, second allocations of the resources for the applications, and labels for the second allocations indicating a negative or positive result. The overall model is trained with the first allocations of the resources and the current allocations in a first training set to output the second allocations of the resources indicated in the first training set with a low confidence level in response to the label indicating the negative result. The overall model is trained with the first allocations of the resources and the current allocations in a first training set to output the second allocations of the resources indicated in the first training set with a high confidence level in response to the label indicating the positive result. Thus, embodiments advantageously allow for retraining of the overall model to reinforce allocation outcomes that optimize allocations across all applications and reduce the likelihood of allocations that do not optimize the results across all applications.

Example 11: The limitations of any of Examples 1-10 may optionally include that the training sets for the overall model further include priorities and categories of the applications and resource thresholds used as further input to train the overall model. Thus, embodiments advantageously allow for retraining of the overall model to optimize allocations across applications with consideration of application categories and priorities to favor application categories and priorities indicating critical applications versus non-critical applications.

Example 12 is an apparatus comprising means to perform a method of any of the Examples 1-11.

Example 13 is a machine-readable storage including machine-readable instructions, that when executed, implement a method or realize an apparatus of any of the Examples 1-11.

Example 14: A system comprising one or more processor and one or more computer-readable storage media collectively storing program instructions which, when executed by the processor, are configured to cause the processor to perform a method according to any of Examples 1-11.

Example 15: A computer program product comprising one or more computer readable storage media, and program instructions collectively stored on the one or more computer readable storage media, the program instructions comprising instructions configured to cause one or more processors to perform a method according to any one of Examples 1-11.

Example 16: The limitation of examples 1, 4, and 11, wherein embodiments advantageously allow for the inputs to the overall model to include categories and priorities of the applications to optimize allocation resources based on application categories and priorities to favor critical versus non-critical applications. Embodiments, further advantageously allow for the training sets to train the overall model to include the priorities and categories to train the overall model to allocate resources to favor critical over non-critical applications.

One challenge in resource allocation management is to determine how to adjust resource allocations to applications when the current allocations are insufficient to support all the applications to operate together at an optimal rate. Further, adjustments to the resource allocations to favor one application may negatively impact the performance of other applications if resources are reassigned from one application to another. An allocation of resources or allocating resources may comprise releasing resources currently assigned to applications and/or increasing or adding to the resources assigned to applications. In this way, an allocation may involve increasing resources allocated to one application and reducing resources allocated to another application.

Described embodiments provide improvements to computing technology to allocate computing resources to applications in a computing environment by monitoring the computing environment for changes to application performance metrics and resource usage. Upon detecting a negative change to performance metrics and resource usage that exceeds a threshold, metrics are gathered to form application data sets of application specific information. These application data sets for the applications are inputted into respective application models to produce application resource allocations for each application that are optimized for the particular application. These application resource allocations are inputted into an overall model along with current resource utilization, resource thresholds, and application metadata to adjust the application resource allocations to optimize allocation across applications and produce final application resource allocations. These final allocations are provided to the computing environment to implement the final resource allocations in the computing environment for the executing applications.

With described embodiments, resource allocations are optimized twice. First within applications and, second, the application specific optimal resource allocations are adjusted to optimize across all applications and the computing environment as a whole.

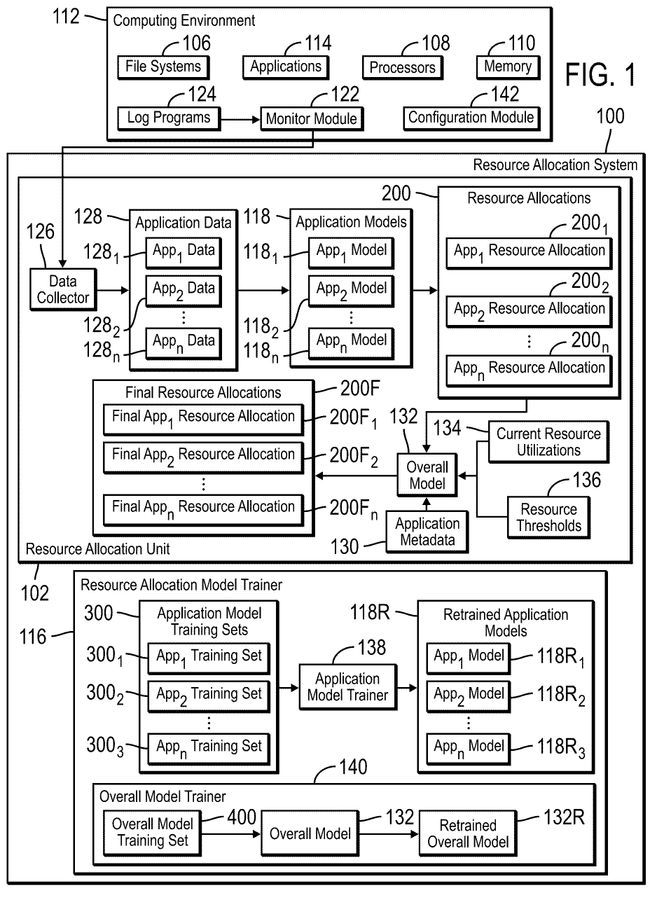

FIG. 1 illustrates an embodiment of a resource allocation system 100 including a resource allocation unit 102 to determine final resource allocations 200F of resources, such as filesystems 106, processors 108, and memory 110 in the computing environment 112, to allocate to applications 114 in the computing environment 112. The term “filesystem” may also be written as “file system. The filesystems 106 may comprise logical storage, such as directories, logical drives, volumes, logical unit numbers (LUNs), etc., used by the applications 114. The resource allocation system 100 further includes a resource allocation model trainer 116 to train application models 118 to produce retrained application models 118R.

A monitor module 122 in the computing environment 112, or operating in the resource allocation system 100, receives logged information from log programs 124. The log programs 124 gather performance metrics from applications 114 operations and usage information for the resources 106, 108, 110. The log programs 124 may comprise, system resource facility type programs, Joblog, etc. The monitor module 122 forwards application performance metrics and resource usage information to a data collector 126. The data collector 126 forms application data 128, comprising an application data set 128₁, 128₂ . . . 128ₙ for each of the n applications. The resource allocation unit 102 inputs application data 128₁, 128₂ . . . 128ₙ for the applications into respective application specific application models 118₁, 118₂ . . . 118ₙ. The application models 118₁, 118₂ . . . 118ₙ process the performance metrics and resource usage information for the specific applications and output optimal resource allocations 200 including application specific resource allocations 200₁, 200₂ . . . 200ₙ.

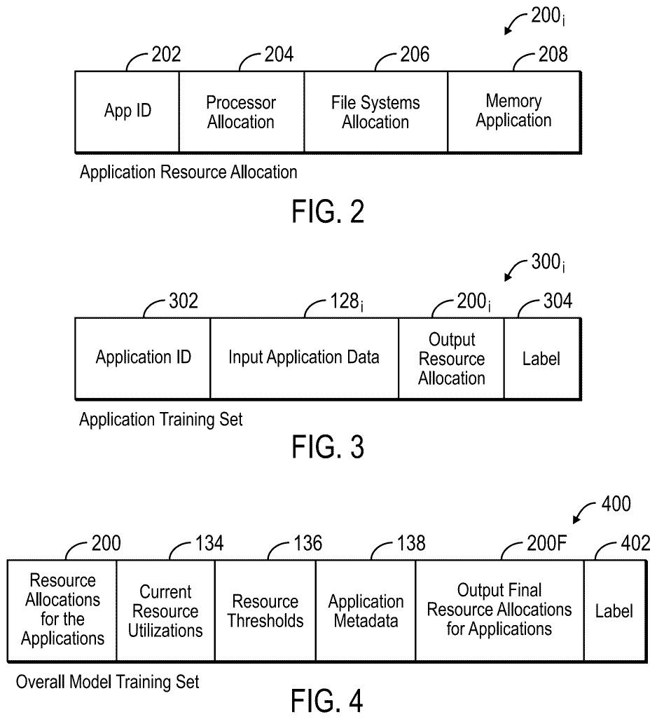

As shown in FIG. 2, an application resource allocation 200ᵢ indicates an application identifier 202 to which the allocation applies, a processor allocation 204 of processor 108 resources, filesystems allocations 206 of the filesystems, and memory allocation 208 of memory resources 110 in the computing environment 112.

The application resource allocations 200 are inputted to an overall model 132 along with input comprising a current resource utilization 134 of the resources 106, 108, 110, resource thresholds 136 indicating threshold amounts of a resource to leave unused, and application metadata 130, including category, priorities, etc. of the applications 114. For instance, for filesystem resources, the resource threshold 136 may indicate a storage utilization limit, indicating a maximum amount of used space for the filesystem storage. In this way, if storage is reassigned from one filesystem to another, an amount of storage would be reassigned such that the utilized storage of the filesystem, from which storage is released/taken, would still fall within the storage utilization limit of the filesystem.

The overall model 132 processes these inputs 200, 134, 136, 138 to output final application resource allocations 200F, including application specific final resource allocations 200F₁, 200F₂ . . . 200Fₙ. The fields of the final application resource allocations 200Fᵢ for an application are described with respect to application resource allocations 200ᵢ in FIG. 2. The final application resource allocations 200F are optimized across all the applications 114, including with respect to priorities of the applications, categories of applications, and other relevant application metadata that can impact resource allocation decisions.

The application resource allocations 200, 200F may comprise an adjustment to the current allocation, such as an amount or percentage, and a direction of the adjustment, such as an increase or decrease of the resource allocation by the specified amount of adjustment. Alternatively, the application resource allocations may specify the absolute amount of the allocation. The application resource allocations may further indicate “unchanged”, to leave the current resource allocation unchanged. The first resource allocation comprises resource allocation 200 and the second resource allocation comprises resource allocation 200F.

The resource application model trainer 116 collects information from applications application model training sets 300 for the applications. A shown in FIG. 3, each application model training set 300ᵢ for an application includes an application identifier (ID) 302 identifying the application, input application data 128ᵢ, the output resource allocation 200ᵢ, and a label 304 indicating the output 200ᵢ as positive (good outcome), negative (bad outcome) or neutral. Alternatively, the label 304 could indicate a score value from 0 to 100 or some other fixed number of degrees of acceptability of the outcome allocation for the application. A training set with a positive label comprises a positive training set to reinforce the application model 118 to output the resource allocation 200ᵢ. A training set with a negative label comprises a negative training set to reinforce the application model 118 to not output the resource allocation 200ᵢ.

In embodiments where the application models 118 comprise machine learning models, an application model trainer 138 uses backpropagation to adjust the weights and biases of nodes in the application models 118 to process the input 128ᵢ to output the output 200ᵢ with a high confidence level, e.g., greater than 85%, if the label 304 is positive indicating the output 200ᵢ resource allocation is good or acceptable. If the label 308 is negative, then the application model trainer 138 uses backpropagation to adjust the weights and biases of the nodes in the application model 118ᵢ to produce the output 200ᵢ from the input 128ᵢ with a low confidence level, e.g., less than 30%. The retraining of the application models 118 results in retrained application models 118R, comprising a retrained application model 118R₁, 118R ₂ . . . 118R n for each application.

The resource allocation model trainer 116 further includes an overall model trainer 140 to retrain the overall model 132. The overall model trainer 140 may collect data for an overall model training set 400. As described with respect to FIG. 4, the overall model training set 400 comprises the inputs to the overall model 132, including the resource allocations for the application 200, current resource utilizations 134, resource thresholds 136, application metadata 130, output final resource allocations 200F for the applications, and a label 402 providing a judgment of the outcome of the output 200F, as positive (good outcome), negative (bad outcome) or neutral. Alternatively, the label 304 could indicate a score value from 0 to 100 or some other fixed number of degrees of acceptability of the outcome allocation for the application.

An overall model training set with a positive label comprises a positive training set to reinforce the overall model 132 to output the resource allocation 200ᵢ. An overall model training set with a negative label comprises a negative training set to reinforce the overall model to not output the resource allocation 200F.

In embodiments where the overall model 132 comprises a machine learning model, the overall model trainer 140 uses backpropagation to adjust the weights and biases of nodes in the overall model 132 to process the inputs 200, 134, 136, 138 to output the final resource allocations 200F with a high confidence level, e.g., greater than 85%, if the label 402 is positive indicating the output final resource allocations 200Fᵢ resource allocation is good or acceptable. If the label 402 is negative, then the overall model trainer 140 uses backpropagation to adjust the weights and biases of the nodes in the overall model 132 to produce the final resource allocations 200F from the inputs 200, 134, 136, 138 with a low confidence level, e.g., less than 30%. The retraining of the overall model 132 results in a retrained overall model 132R.

A confidence level comprises an estimate of the extent the output resource allocations 200 and 200F from the inputs correctly predict the output resource allocations, or a probability estimate the output resource allocations 200 and 200F from the models 118, 132 should themselves be measures of confidence.

The retrained application models 118R and overall model 132R are deployed in the resource allocation unit 102 to replace the application models 118 and overall model 132 to use during resource allocation operations.

The computing environment 112 may include a configuration module 142 to configure the resources 106, 108, 110 to allocate the resources in the final resource allocations 200F to the applications 114.

The arrows shown in FIG. 1 between the components and objects in the storage controller represent a data flow between the components.

Generally, program modules, such as the program components 102, 114, 116, 122, 124, 126, 118, 132, 132R, 138, 118R, 140, 142, among others, may comprise routines, programs, objects, components, logic, data structures, and so on that perform particular tasks or implement particular abstract data types. The program components and hardware devices of the system 100 and computing environment 112 may be implemented in one or more storage systems or computer systems, where if they are implemented in multiple storage systems or computer systems, then the storage systems or computer systems may communicate over a network or a bus.

The program components 102, 114, 116, 122, 124, 126, 118, 132, 132R, 138, 118R, 140, 142, among others, may be accessed by a processor from memory to execute. Alternatively, some or all of the program components 102, 114, 116, 122, 124, 126, 118, 132, 132R, 138, 118R, 140, 142, among others, may be implemented in separate hardware devices, such as Application Specific Integrated Circuit (ASIC) hardware devices, Graphical Processing Units (GPUs), Data Processing Units (DPUs), and/or Field Programmable Gate Arrays (FPGAs).

The functions described as performed by the program components 102, 114, 116, 122, 124, 126, 118, 132, 132R, 138, 118R, 140, 142, among others, may be implemented as program code in fewer program modules than shown or implemented as program code throughout a greater number of program modules than shown.

Program components implementing machine learning models, such as program components 118, 118R, 132, 132R, among others, may be implemented in an Artificial Intelligence (AI) hardware accelerator, such as an FPGA or a GPU.

In certain embodiments, program components 118, 118R, 132, 132R, among others, may use machine learning and deep learning algorithms, such as decision tree learning, association rule learning, neural network, inductive programming logic, support vector machines, Bayesian network, Reinforced Neural Network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used by the trainers 138, 140 to train a neural network machine learning module, such as the models 118, 132, biases at nodes in the hidden layer are adjusted accordingly to produce the output, such as application resource allocations, with specified confidence levels based on the input parameters. The program components 118, 118R, 132, 132R, among others, may be trained to produce their output from feedback and their output based on the input. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation performed by the trainers 138, 140 to train neural network machine learning modules, such as the program components 118, 132, margins of error are determined based on a difference of the calculated predictions and user rankings of the output. Biases (parameters) at nodes in the hidden layer are adjusted accordingly to minimize the margin of error of the error function.

In an alternative embodiment, the components 118, 118R, 132, 132R may be implemented not as a machine learning module, but implemented using a rules based or heuristic system to determine the outputs from the inputs, and other methods, such as multivariable linear regression models. The components 118, 118R, 132, 132R may alternatively be implemented using an unsupervised machine learning module.

The computing environment 112 may comprise a cloud or enterprise computing environment including virtual machines and physical machines. The resource allocation system 100 may comprise a server.

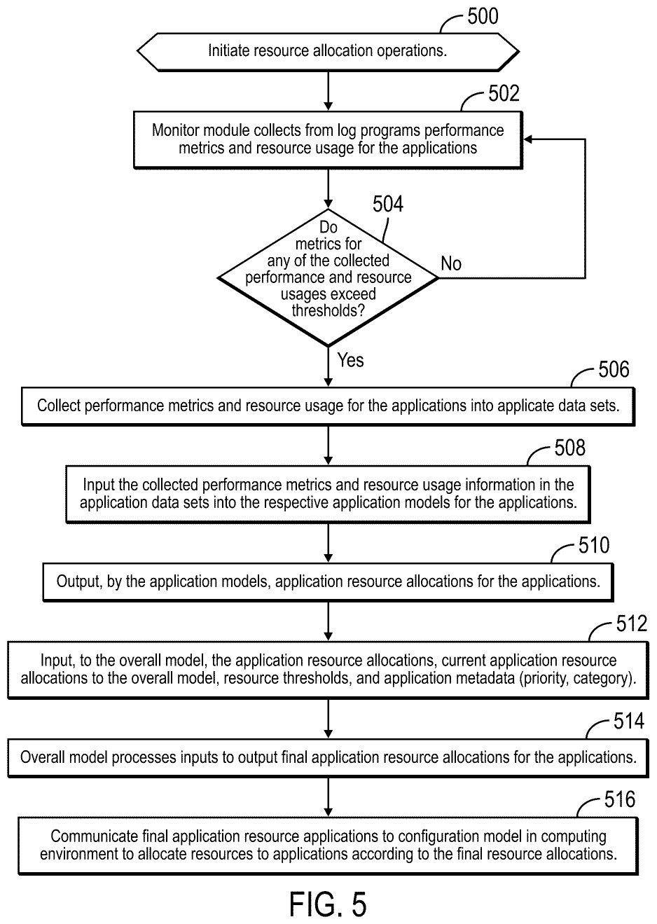

FIG. 5 illustrates an embodiment of operations performed by components of a resource allocation unit to determine resource allocations for applications in a computing environment. Application models for the applications determine application specific resource allocations and an overall model optimizes the application resource allocations across applications. In certain embodiments, the resource allocation unit, application models, and overall model may comprise components 102, 118, 132, among others, described with respect to FIG. 1. Upon initiating (at block 500) resource allocation operations, a monitor module in the computing environment 112 (e.g., monitor module 122 in computing environment 112), collects from log programs, e.g., log programs 124, performance metrics and resource usage for applications, e.g., applications 114, in the computing environment. The performance metrics may include response time of requests to the applications, Input/Output throughput at the applications, read/write rate, error rates, etc. The resources allocated to the applications may comprise filesystems, processors, and memory.

A determination is made (at block 504) whether any of the performance metrics and resource usages exceed thresholds for the specific metrics. If not, then control proceeds back to block 502 to continue to collect information from the monitor module. If (at block 504) any of the performance metrics and resource usages at the computing environment exceed thresholds, then a data collector, e.g., data collector 126, collects performance metrics and resource usage information for the applications into application data sets, e.g., application data sets 128, for each of the applications. One application data set may provide information for one of the applications.

The collected application data sets, including performance metrics and resource usage for each application, are inputted (at block 508) into the application models to process. Each application model specific to an application may receive the application data set specific to that application. The application models output (at block 510) application resource allocations, e.g., resource allocations 200, for the applications. The application resource allocations from the application models, current application resource allocations in the computing environment, resource thresholds, and application metadata are inputted (at block 512) into an overall model, e.g., overall model 132. The overall model processes (at block 514) all the inputs to output final application resource allocations, e.g., final resource allocations 200F. The final application resource allocations are optimized across all applications, taking into account application information, such as application categories and priority. The resource allocation unit communicates (at block 516) the final application resource allocations to a component, e.g., configuration model 142, in the computing environment to allocate the resources to the applications according to the final resource allocations.

In processing resource thresholds 136, the overall model may ensure that the final resource allocation satisfies all resource thresholds. For instance, filesystem may have resource thresholds comprising storage utilization limits, such that only a certain percentage of the filesystem storage space may be utilized. In this way, when reassigning space from one filesystem storage to another filesystem requiring additional storage, an amount of storage will not be reassigned from the filesystem storage that would cause the filesystem storage utilization, from which storage is taken/reassigned, to exceed a storage utilization limit.

With the embodiment of FIG. 5, application specific models, such as machine learning models, determine optimal allocations for each application based on application specific metrics and resource usage. This provides optimization of each application's resources independent of other applications. Then an overall model, such as a machine learning model, further optimizes the application specific resource allocations across all applications, taking into account application specific requirements, such as application category and priority, as well as threshold limits on total resource usage. The output of the overall model provides a final resource allocation that although may not be optimal for one specific application, adjusts the application specific optimal resource allocations to optimize across all applications and resource limits.

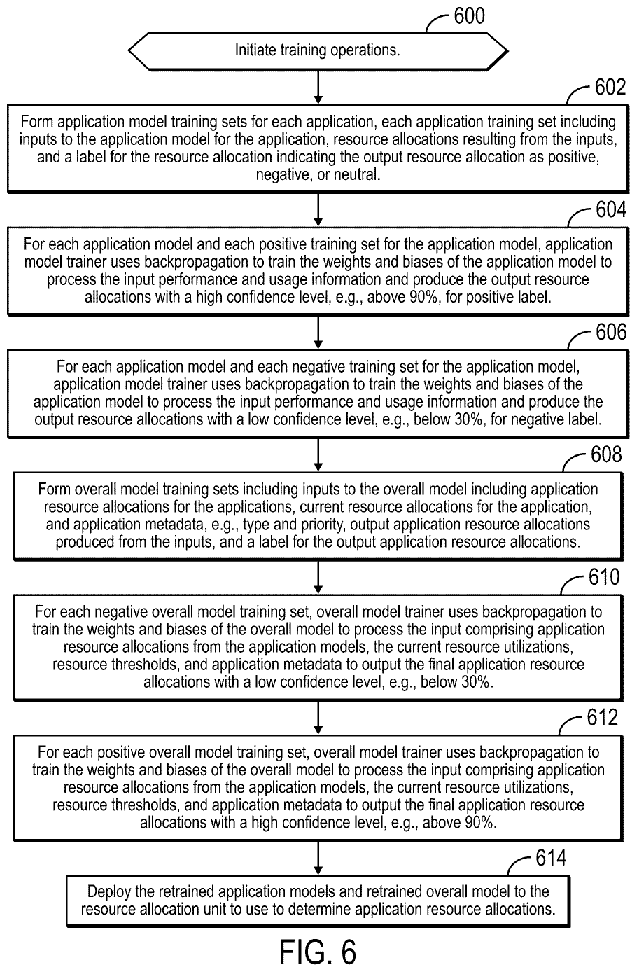

FIG. 6 illustrates an embodiment of operations performed in components of a resource allocation model trainer, including an application model trainer to retrain application models and overall model trainer to retrain the overall model. In certain embodiments, the resource allocation model trainer, overall model trainer, application model trainer, application models and overall model may comprise components 116, 140, 138, 118, and 132, respectively, as shown in FIG. 1. Upon initiating (at block 600) training operations, the resource allocation model trainer forms (at block 602) application model training sets, e.g., training sets 300, for each application. Each application training set includes inputs, such as performance metrics and resource usage information, to the application model for the application, resource allocations resulting from the inputs, and a label for the resource allocations indicating whether the output resource allocation as positive, negative, or neutral. For each application model and each positive training set for the application model, where a positive training set comprises a training set having a positive label, the application model trainer uses (at block 604) backpropagation to train the weights and biases of the application model to process the input performance and usage information and produce the output resource allocations with a high confidence level, e.g., above 90%. The confidence level indicates an estimated likelihood/probability the output resource allocations are correct based on the inputs.

For each application model and each negative training set for the application model, where a negative training set comprises a training set having a negative label, the application model trainer uses (at block 606) backpropagation to train the weights and biases of the application model to process the input performance and usage information and produce the output resource allocations with a low confidence level, e.g., below 30%.

To train the overall model, the resource allocation model trainer forms (at block 608) overall model training sets including inputs to the overall model including application resource allocations for the applications, current resource allocations for the application, application metadata, e.g., type and priority, final application resource allocations, e.g., 200F, the overall model produced from the inputs, and a label for the output application resource allocations indicating whether the final application resource allocations were positive, negative or neutral.

For each negative overall model training set, i.e., having a negative label, the overall model trainer uses (at block 610) backpropagation to train the weights and biases of the overall model to process the input comprising application resource allocations from the application models, the current resource utilizations, resource thresholds, and application metadata to output the final application resource allocations with a low confidence level, e.g., below 30%. For each positive overall model training set, having a positive label, the overall model trainer uses (at block 612) backpropagation to train the weights and biases of the overall model to process the input comprising application resource allocations from the application models, the current resource utilizations, resource thresholds, and application metadata to output the final application resource allocations with a high confidence level, e.g., above 90%.

The retrained application models, e.g., 118R, and the retrained overall model, e.g., 132R, are deployed (at block 614) to the resource allocation unit to use to determine application resource allocations in the computing environment.

With the embodiment of operations of FIG. 6, the application models and overall model may be continually trained on inputs to the application and overall models, the resource allocations, and final resource allocations, labeled with an outcome indicating positive, negative or neutral, to improve the machine learning model neural networks to more accurately predict application resource allocations and final application resource allocations.

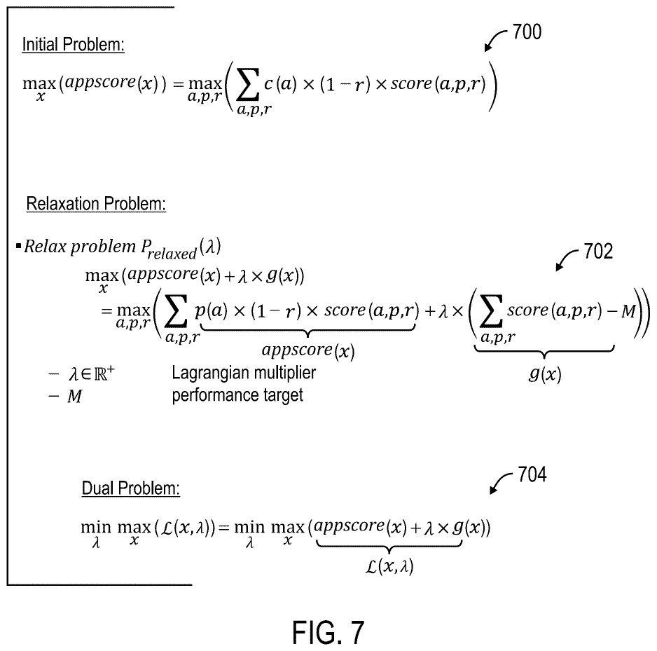

In certain embodiments, the application model trainer and overall model trainer may use a Lagrangian relaxation optimization technique that calculates an adjustment rate of the allocation of the computational resources to optimize the allocation using a Lagrangian dual problem to perform a min-max of an application score function for a performance type. With respect to optimizing the application models, the initial problem for Lagrangian relaxation would be to optimize the application performance score for an application (a), calculated according to the initial problem 700 shown in FIG. 7. In the initial problem 700, variable “a” is the application, “c(a)” is the current application score, “p” is an application attribute, such as type, priority weight, etc., “r”, is the adjustment rate, and “x” is the performance type of the application. The equation seeks to optimize the adjustment to the current score(a, p, r) to maximize the application score (appscore).

The relaxation problem may then be created with the Lagrangian multiplier λ, which is a member of the set of real positive numbers, from the initial problem as shown in the relaxation problem 702 P_{relaxed} (λ). With this relaxation problem 702, the Lagrangian dual problem 704 is solved to determine the optimal adjustments (r) to the resource allocations. In the relaxation problem, g(x) comprises the current score, and the appscore(x) is the application score to maximize based on a resource adjustment (r) to the application score.

The Lagrangian relaxation technique may also be used to determine the adjustment to the resource allocation (r) for the overall model.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

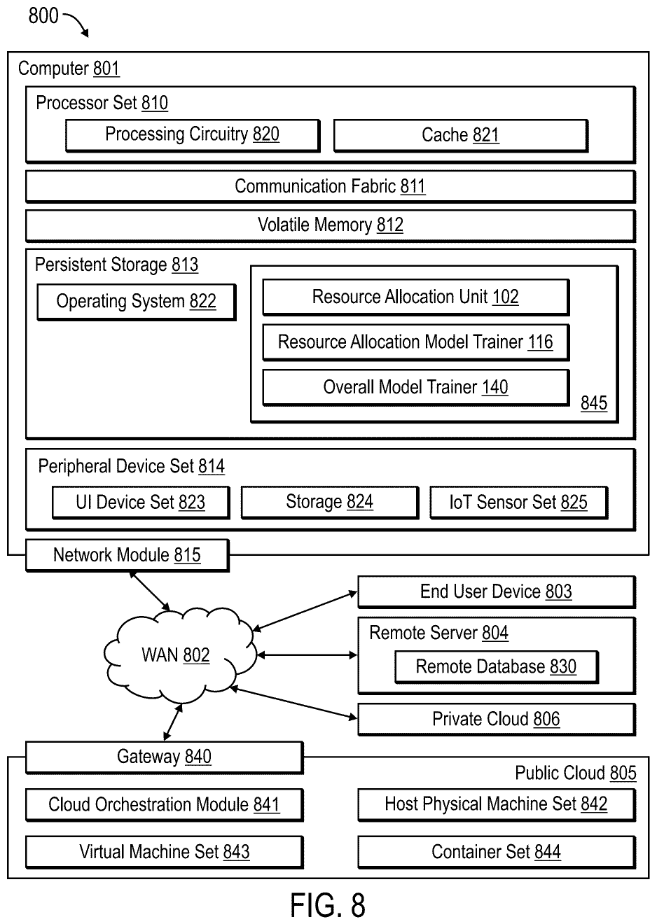

With respect to FIG. 8, computing environment 800 contains an example of an environment for the execution of at least some of the computer code involved in performing the inventive methods, such as the resource allocation unit 102, resource allocation model trainer 116, and overall model trainer 140 as shown in FIG. 1 and described above, in block 845. In addition to block 845, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844. The components in block 845 may be implemented in persistent storage 813 and/or a hardware processing unit, such as a graphical processing unit (GPU).

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer-readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 845 in persistent storage 813 and/or other hardware processing units, e.g., GPUs.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer-readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. The public cloud 805 may implement the computing environment, such as computing environment 112 in FIG. 1, that includes the applications subject to the resource allocations performed by the resource allocation unit.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud. The private cloud 806 may implement the computing environment, such as computing environment 112 in FIG. 1, that includes the applications subject to the resource allocations performed by the resource allocation unit.

CLOUD COMPUTING SERVICES AND/OR MICROSERVICES (not separately shown in FIG. 8): private and public clouds 806 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for allocating resources to applications in a computing environment, comprising:
collecting performance metrics and resource usage information for the applications;
inputting the collected performance and resource usage information for the applications to application models for the applications to generate first allocations of resources for the applications, wherein there is one application model for each application;
inputting the first allocations of the resources and current allocations of resources to the applications to an overall model to generate second allocations of the resources for the applications to optimize allocations of resources across the applications; and
allocating the resources to the applications according to the second allocations of the resources.

2. The computer implemented method of claim 1, wherein the application models and the overall model comprise machine learning models.

3. The computer implemented method of claim 1, wherein the collecting the performance and resource usage information for the applications comprises:
determining whether a metric based on the collected performance and resource usage information for an application satisfies a threshold requirement for the metric, wherein the inputting the collected performance and resource usage information to the application models, the inputting the first allocations and the current allocations of resources, and the allocating the resources according to the second allocations in response to determining that the metric satisfies the threshold requirement.

4. The computer implemented method of claim 1, wherein inputs to the overall model to generate the second allocations include categories and priorities of the applications.

5. The computer implemented method of claim 1, wherein the performance metrics for the applications is selected from the group consisting of response time of requests to the applications, Input/Output throughput at the applications, read/write rate, and error rates, and wherein the resource usage information is selected from the group consisting of allocated processor resources, allocated memory resources, and allocated storage for filesystems used by the applications.

6. The computer implemented method of claim 1, wherein the first and the second allocations indicate for the applications a positive adjustment to increase a resource allocation to an application, a negative adjustment to decrease the resource allocation to an application, and indication to leave a resource allocation to an application unchanged.

7. The computer implemented method of claim 1, wherein the resources include filesystems, wherein threshold allocation limits indicate storage utilization limits for the filesystems, wherein the overall model produces the second allocations to reassign an amount of storage resources from a filesystem such that a storage utilization of the filesystem, from which storage resources are reassigned, remains within a storage utilization limit for the filesystem.

8. The computer implemented method of claim 1, wherein the application models comprise machine learning models, further comprising:
providing training sets for an application model for an application of the application models including input comprising performance and resource usage information for the application, an outputted allocation of resources to the application from the application model, and a label for the outputted allocation indicating a negative result or positive result;
training the application model with the input performance metrics and resource usage information in a first training set to output the outputted allocation of the resources indicated in the first training set with a low confidence level in response to the label indicating the negative result; and
training the application model with the input performance metrics and resource usage information in a second training set to output the outputted allocation of the resources indicated in the second training set with a high confidence level in response to the label indicating the positive result.

9. The computer implemented method of claim 8, wherein the application models are trained using a Lagrangian relaxation optimization technique that calculates adjustment rates of allocations of the resources optimized using a Lagrangian dual problem to perform a min-max of an application score function for a performance type.

10. The computer implemented method of claim 1, wherein the overall model comprises a machine learning model, further comprising:
providing training sets for the overall model including input comprising first allocations of resources for the applications, the current allocations of resources to the applications, second allocations of the resources for the applications, and labels for the second allocations indicating a negative or positive result;
training the overall model with the first allocations of the resources and the current allocations in a first training set to output the second allocations of the resources indicated in the first training set with a low confidence level in response to the label indicating the negative result; and
training the overall model with the first allocations of the resources and the current allocations in a first training set to output the second allocations of the resources indicated in the first training set with a high confidence level in response to the label indicating the positive result.

11. The computer implemented method of claim 10, wherein the training sets for the overall model further include priorities and categories of the applications and resource thresholds used as further input to train the overall model.

12. A computer system for allocating resources to applications in a computing environment, comprising:
a processor set;
one or more computer-readable storage media; and
program instructions stored on the one or more computer-readable storage media to cause the processor set to perform operations comprising:
collecting performance metrics and resource usage information for applications;
inputting the collected performance and resource usage information for the applications to application models for the applications to generate first allocations of resources for the applications, wherein there is one application model for each application;
inputting the first allocations of the resources and current allocations of resources to the applications to an overall model to generate second allocations of the resources for the applications to optimize allocations of resources across the applications; and
allocating the resources to the applications according to the second allocations of the resources.

13. The computer system of claim 12, wherein the collecting the performance and resource usage information for the applications comprises:
determining whether a metric based on the collected performance and resource usage information for an application satisfies a threshold requirement for the metric, wherein the inputting the collected performance and resource usage information to the application models, the inputting the first allocations and the current allocations of resources, and the allocating the resources according to the second allocations in response to determining that the metric satisfies the threshold requirement.

14. The computer system of claim 12, wherein the resources include filesystems, wherein threshold allocation limits indicate storage utilization limits for the filesystems, wherein the overall model produces the second allocations to reassign an amount of storage resources from a filesystem such that a storage utilization of the filesystem, from which storage resources are reassigned, remains within a storage utilization limit for the filesystem.

15. The computer system of claim 12, wherein the application models comprise machine learning models, wherein the operations further comprise:
providing training sets for an application model for an application of the application models including input comprising performance and resource usage information for the application, an outputted allocation of resources to the application from the application model, and a label for the outputted allocation indicating a negative result or positive result;
training the application model with the input performance metrics and resource usage information in a first training set to output the outputted allocation of the resources indicated in the first training set with a low confidence level in response to the label indicating the negative result; and
training the application model with the input performance metrics and resource usage information in a second training set to output the outputted allocation of the resources indicated in the second training set with a high confidence level in response to the label indicating the positive result.

16. The computer system of claim 12, wherein the overall model comprises a machine learning model, wherein the operations further comprise:
providing training sets for the overall model including input comprising first allocations of resources for the applications, the current allocations of resources to the applications, second allocations of the resources for the applications, and labels for the second allocations indicating a negative or positive result;
training the overall model with the first allocations of the resources and the current allocations in a first training set to output the second allocations of the resources indicated in the first training set with a low confidence level in response to the label indicating the negative result; and
training the overall model with the first allocations of the resources and the current allocations in a first training set to output the second allocations of the resources indicated in the first training set with a high confidence level in response to the label indicating the positive result.

17. A computer program product for allocating resources to applications in a computing environment, comprising:
one or more computer-readable storage media; and
program instructions stored on the one or more computer-readable storage media to perform operations comprising:
collecting performance metrics and resource usage information for applications;
inputting the collected performance and resource usage information for the applications to application models for the applications to generate first allocations of resources for the applications, wherein there is one application model for each application;
inputting the first allocations of the resources and current allocations of resources to the applications to an overall model to generate second allocations of the resources for the applications to optimize allocations of resources across the applications; and
allocating the resources to the applications according to the second allocations of the resources.

18. The computer program product of claim 17, wherein the collecting the performance and resource usage information for the applications comprises:
determining whether a metric based on the collected performance and resource usage information for an application satisfies a threshold requirement for the metric, wherein the inputting the collected performance and resource usage information to the application models, the inputting the first allocations and the current allocations of resources, and the allocating the resources according to the second allocations in response to determining that the metric satisfies the threshold requirement.

19. The computer program product of claim 17, wherein the resources include filesystems, wherein threshold allocation limits indicate storage utilization limits for the filesystems, wherein the overall model produces the second allocations to reassign an amount of storage resources from a filesystem such that a storage utilization of the filesystem, from which storage resources are reassigned, remains within a storage utilization limit for the filesystem.

20. The computer program product of claim 17, wherein the application models comprise machine learning models, wherein the operations further comprise:
providing training sets for an application model for an application of the application models including input comprising performance and resource usage information for the application, an outputted allocation of resources to the application from the application model, and a label for the outputted allocation indicating a negative result or positive result;
training the application model with the input performance metrics and resource usage information in a first training set to output the outputted allocation of the resources indicated in the first training set with a low confidence level in response to the label indicating the negative result; and
training the application model with the input performance metrics and resource usage information in a second training set to output the outputted allocation of the resources indicated in the second training set with a high confidence level in response to the label indicating the positive result.
